(19) United States
(12) Patent Application Publication
(10) Pub. No.: US 2015/0078821 A1
(43) Pub. Date: Mar. 19, 2015

(54) POLYISOCYANURATE FOAM COMPOSITES FOR USE IN GEOFOAM APPLICATIONS

(71) Applicant: FIRESTONE BUILDING PRODUCTS CO, LLC, Indianapolis, IN (US)

(72) Inventors: Timothy D. TACKETT, Sheridan, IN (US); Greg ORTWEIN, Indianapolis, IN (US)

(21) Appl. No.: 14/491,083

(22) Filed: Sep. 19, 2014

Related U.S. Application Data
(60) Provisional application No. 61/879,717, filed on Sep. 19, 2013.

(51) Int. Cl. B64F 1/36; E01C 9/00; E01B 1/00; E01C 3/00; E01C 11/00

(52) U.S. Cl. CPC B64F 1/36; E01C 3/003; E01C 11/00; E01B 1/002; E01C 9/001
USPC 404/28; 238/6; 244/114 R

(57) ABSTRACT

A road system comprising a finished road surface and a geofoam positioned below the road surface, where the geofoam includes a foam core and a facer including a fibrous mat and an interfacial region disposed between said foam core and said fibrous mat.

This application claims the benefit of U.S. Provisional Application Ser. No. 61/879,717, filed on Sep. 19, 2013, which is incorporated herein by reference.

### FIELD OF THE INVENTION

Embodiments of the present invention are directed toward the use of polyisocyanurate foam composites in geofoam applications.

### BACKGROUND OF THE INVENTION

Geofoams have long been used as geotechnical materials. These foams offer light-weight fill alternatives to rock, gravel, and soil, and they thereby offer advantages in many geotechnical engineering situations. Extruded polystyrene, which may also be referred to as XPS, has been widely used as a geofoam. Among several advantages, XPS is fabricated to include exterior layers, which may also be referred to as skin layers, which serve as a moisture barrier. Generally, this skin is formed during the manufacturing process where the developing foam contacts the surface of equipment or forms in which the XPS is manufactured. In other words, the skin layer is the direct result of the manufacturing process and therefore additional constituents, such as facers, are not required. While XPS has several advantages, there are many geotechnical applications that would benefit from geofoams having mechanical properties greater than can be offered by XPS.

### SUMMARY OF THE INVENTION

One or more embodiments of the present invention provides a road system comprising a finished road surface and a geofoam positioned below the road surface, where the geofoam includes a foam core and a facer including a fibrous mat and an interfacial region disposed between said core and said mat.

Still other embodiments of the present invention provide a railway system comprising a railway and a geofoam positioned below the railway, where the geofoam includes a foam core and a facer including a fibrous mat and an interfacial region disposed between said core and said mat.

Still other embodiments of the present invention provide an airport runway or taxiway comprising a finished airport runway or taxiway and a geofoam positioned below the airport runway or taxiway, where the geofoam includes a foam core and a facer including a fibrous mat and an interfacial region disposed between said core and said mat.

Still other embodiments of the present invention provide a bridge structure comprising a bridge, bridge abutments positioned next to the bridge, and a geofoam positioned below the bridge abutments, where the geofoam includes a foam core and a facer including a fibrous mat and an interfacial region disposed between said core and said mat.

Still other embodiments of the present invention provide a stadium or theater structure comprising a finished stadium or theater surface and a geofoam positioned below the finished stadium or theater surface, where the geofoam includes a foam core and a facer including a fibrous mat and an interfacial region disposed between said core and said mat.

Still other embodiments of the present invention provide a parking garage comprising a finished parking garage surface and a geofoam positioned below the finished parking garage surface, where the geofoam includes a foam core and a facer including a fibrous mat and an interfacial region disposed between said core and said mat.

Still other embodiments of the present invention provide a residential structure comprising an exterior sub-surface wall and a geofoam positioned next to the exterior subsurface wall, where the geofoam includes a foam core and a facer including a fibrous mat and an interfacial region disposed between said core and said mat.

### BRIEF DESCRIPTION OF THE DRAWINGS

FIG. 1 is a perspective view of a geofoam composite according to embodiments of the invention.

FIG. 2 is a cross-sectional schematic view of a geofoam composite according to embodiments of the invention.

FIG. 3 is a cross-sectional schematic view of a geofoam composite according to embodiments of the invention.

FIG. 4 is cross-sectional schematic view of a road construction according to embodiments of the invention.

FIG. 5 is a cross-sectional schematic view of a bridge abutment according to embodiments of the invention.

FIG. 6 is a cross-sectional schematic view of a railroad bed according to embodiments of the invention.

FIG. 7 is a cross-sectional schematic view of a stadium or theater structure according to embodiments of the invention.

FIG. 8 is a cross-sectional schematic view of an airport runway or taxiway construction according to embodiments of the invention.

FIG. 9 is a cross-sectional schematic view of a parking garage according to embodiments of the invention.

FIG. 10 is cross-sectional schematic view of a residential structure according to embodiments of the invention.

### DETAILED DESCRIPTION OF ILLUSTRATIVE EMBODIMENTS

Embodiments of the invention are based, at least in part, on the discovery of polyisocyanurate geofoam composites that include a fibrous mat facer and an interfacial region disposed between the mat and the foam core of the composite. While the prior art acknowledges the usefulness of EPS within geofoam applications, it has unexpectedly been discovered that the polyisocyanurate foam composites of this invention have sufficient moisture resistant properties to render them useful in geotechnical applications. Additionally, since the polyisocyanurate geofoam composites of this invention can be made with a wide range of core densities, further advantages can be realized in geotechnical applications.

### Geofoam Composite Construction

### Configuration of Geofoam Composite

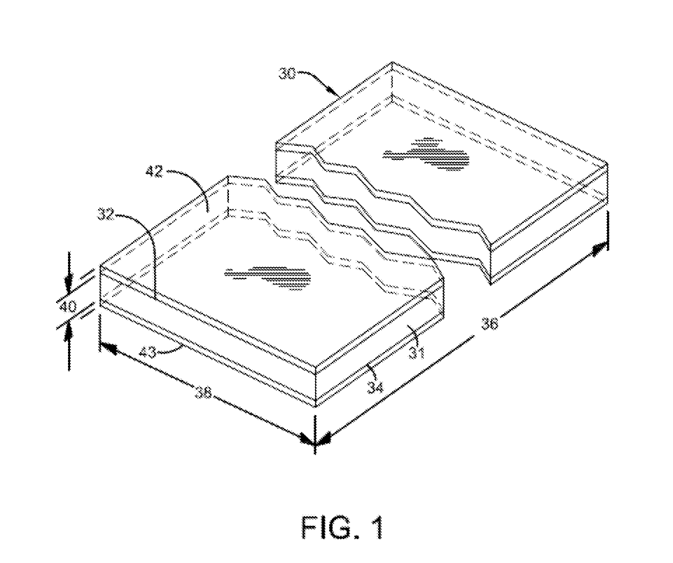

A polyisocyanurate geofoam composite, which may also be referred to as a board, ISO board, or construction board, according to one or more embodiments is depicted in FIG. 1. Composite 30 includes a cellular body or foam core 31, which may have, for example, a planar shape, and includes first planar surface 32 and second planar surface 34. Foam core 31 may also be characterized by a thickness 40, a length 36, and a width 38. The thickness 40, length 36 and width 38 of composite 30 may vary, and these embodiments are not necessarily limited by the selection of a particular thickness, length, or width. Likewise, the general shape of the overall composite may vary depending on the desired application. For example, the composite may have a cubical or cuboidal structure (e.g. a rectangular cube). In certain embodiments, however, the composites of this invention may be sized to a 4′×8′ sheet (e.g., 3.75′×7.75′), a 4′×10′ sheet, or a 4′×4′ sheet. In these or other embodiments, the thickness 40 of the foam core can generally be greater than 0.25 inches, in other embodiments greater than 0.5 inches, and in other embodiments greater than 1.0 inches. In these or other embodiments, the thickness 40 of the foam core can be less than 1 foot, in other embodiments less than 6 inches, and in other embodiments less than 4 inches. In one or more embodiments, the thickness of the board may be from 0.5 to 4.0 inches.

Composite 30 includes a first facer 42, which can be positioned adjacent one of the first or second planar surfaces 32 or 34. For example, as shown in FIG. 1, facer 42 may be positioned adjacent second planer surface 32. In one or more embodiments, facer 42 can be integral with planar surface to which it is adjacent as a result of the methods employed to manufacture composite 30, which will be disclosed below.

As also shown in FIG. 1, composite 30 may also include a second optional facer 43 positioned adjacent the planer surface opposite the planar surface on which facer 42 is positioned. For example, facer 42 is positioned adjacent second planer surface 32, and facer 43 is positioned adjacent first planer surface 34. Facer 43 can include the same or different materials or compositions, as well as the same or different thickness as facer 42.

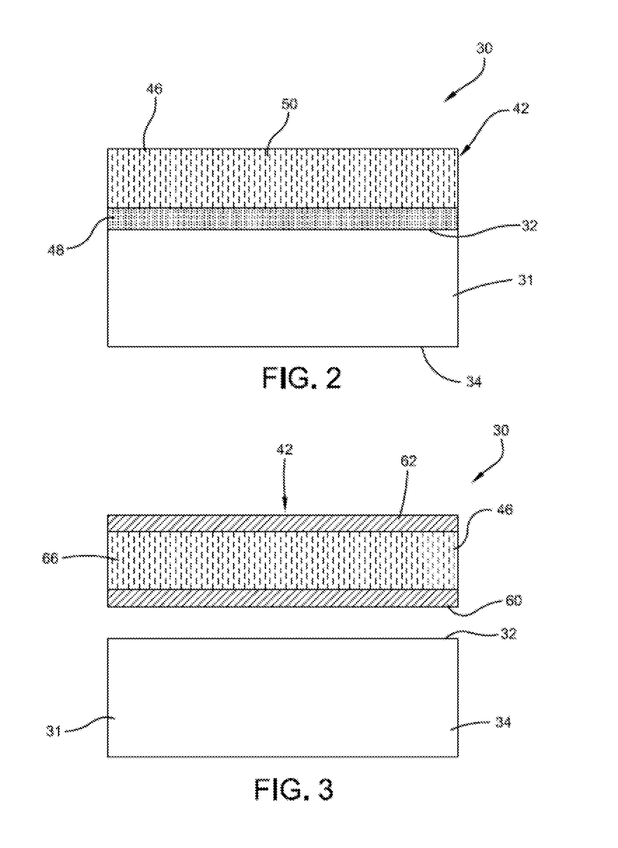

As shown in FIG. 2, at least one of the facers (e.g. facer 42 and/or facer 43) includes a mat 46 and a coating layer 48. Mat 46 may also be referred to as fabric 46. Coating layer 48 may also be referred to as interfacial region 48, and comprises coating material. The coating material may also optionally be dispersed in interstices that exist within mat 46, and this coating material may generally be referred to as penetrated coating material 50. As shown in FIG. 3, at least one of the facers (e.g. facer 42 and/or facer 43) includes first coating layer 60 and second coating layer 62, as well as mat 46 and an optional penetrated coating material 66, where layer 60 may be referred to as interfacial region 60.

### Mat

As described above, one or more of the facers employed in practicing this invention (e.g. facer 42 and/or facer 43) includes a mat (e.g. mat 46). In one or more embodiments, the mat is a non-woven inorganic mat. Exemplary types of non-woven mat include fiberglass mats, which may also be referred to as glass mats. In one or more embodiments, the non-woven fiberglass mats include glass fibers and a binder which binds the glass fibers together and maintains the fibers in a mat form. Any type of glass fiber mat can be used in the composite board. For example, a non-woven glass fiber mat can be made with glass fibers and bonded with an aqueous thermosetting resin such as, for example, urea formaldehyde or phenolic resole resins.

In one or more embodiments, the dimensional and weight characteristics of the glass fiber mat are not particularly limited, and can depend on the specific application and desired properties of the polyisocyanurate geofoam composite. For example, the basis weight of the glass fiber mat 46 can be from about 50 grams per square meter to about 150 grams per square meter. The thickness of the glass fiber mat 46 can be, for example, from about 0.015 inch to about 0.05 inch. The basis weight and thickness characteristics can be adjusted depending upon the desired rigidity, strength and weight of the composite board.

The thickness of the facer material may vary; for example, it may be from about 0.01 to about 1.00 or in other embodiments from about 0.015 to about 0.050 inches thick.

### Coating Material

As described above, one or more of the facers employed in practicing this invention (e.g. facer 42 and/or facer 43) includes one or more coating layers (e.g. coating layer 48, 60, or 62), as well as optional coating material disposed within the interstices of the mat, in which the optional coating material is referred to as a penetrated coating material (e.g. 50 or 66).

In one or more embodiments, the coating layers, as well as the coating material, include a binder and an inorganic filler. The binder bonds the inorganic filler together and additionally bonds the inorganic filler to the glass fiber mat. The binder can be polymeric and derive from, for example, a latex binder, a starch or combinations thereof. Examples of latex binders include butyl rubber latex, styrene butadiene rubber (SBR) latex, neoprene latex, acrylic latex and SBS latex, and can in particular include the SBR latex. In one embodiment, each of the first and second binding compositions can include from about 1% latex to about 15% latex, based on the respective weight of each binding composition. In another embodiment, each of the first and second binding compositions can include from about 1% latex to about 5% latex, based on the respective weight of each binding composition. Examples of a suitable inorganic filler include calcium carbonate, clay, talc, mica, perlite, hollow ceramic spheres or a combination thereof. In an exemplary embodiment, the inorganic filler can include calcium carbonate. In an exemplary embodiment, the inorganic filler can be present in the first and second binding compositions in an amount from about 80% to about 98%, based on the respective weight of each composition.

In one or more embodiments, the coating layers (e.g. layers 48, 60, or 62), as well as the penetrated coating material (e.g. 50 or 66), allow for a relatively high degree of air permeability of the facer. In one or more embodiments, the coating layers (e.g. layers 48, 60, or 62) are discontinuous or irregular (e.g. have an irregular thickness), and the penetrated coating material (e.g. 50 or 62) may not fill all of the interstices of the mat 46, either of which may contribute to the relatively high degree of air permeability of the facer (e.g. facer 42 and/or facer 43).

In one or more embodiments, coating layers (e.g. layers 48, 60, or 62), as well as penetrated coating material (e.g. 50 or 66), derives from employing a double-coated glass mat, which is a glass mat that includes coating material applied to both planar surfaces of the glass mat.

In one or more embodiments, the double-coated facer is characterized by an air permeability, which may also be referred to as porosity, as determined by ARC-WT-006 (which correlates to TAPPI T460om-96), of less than 300, in other embodiments less than 250, in other embodiments less than 200, in other embodiments less than 150, in other embodiments less than 100, in other embodiments less than 70, in other embodiments less than 50, in other embodiments less than 40, and in other embodiments less than 30 Gurley seconds/300 cubic centimeters.

In one or more embodiments, the double-coated facer is characterized by a coating weight of greater than 500, in other embodiments greater than 600, in other embodiments greater than 700, in other embodiments greater than 800, in other embodiments greater than 810, in other embodiments greater than 820, in other embodiments greater than 830, in other embodiments greater than 840, in other embodiments greater then 850, in other embodiments greater then 860, in other embodiments greater 870, in other embodiments greater 880, in other embodiments greater than 890, and in other embodiments greater than 900 grams per square meter. In one or more embodiments, the coating weight is less than 1000, in other embodiments less than 950, and in other embodiments less than 920 grams per square meter. As used herein, the term “coating weight” means the weight of the coating per area of the at least one glass fiber mat, which includes both coating layers as well as the penetrated coating material.

### Foam Core

In one or more embodiments, body 31 includes a polyurethane or polyisocyanurate cellular structure, which refers to an interconnected network of solid struts or plates that form the edges and faces of cells. These cellular structures may, in one or more embodiments, also be defined by a “relative density” that is less than about 0.8, in other embodiments less than 0.5, and in other embodiments less than 0.3. As those skilled in the art will appreciate, “relative density” refers to the density of the cellular material divided by that of the solid from which the cell walls are made. As the relative density increases, the cell walls thicken and the pore space shrinks such that at some point there is a transition from a cellular structure to one that is better defined as a solid containing isolated porosity.

In certain embodiments, body 31 has a relatively high density. In one or more embodiments, the density of body 31 is greater than 2.5 pounds per cubic foot (12.2 kg/m²), as determined according to ASTM C303, in other embodiments the density is greater than 2.8 pounds per cubic foot (13.7 kg/m²), in other embodiments greater than 3.0 pounds per cubic foot (14.6 kg/m²), and still in other embodiments greater than 3.5 pounds per cubic foot (17.1 kg/m²); on the other hand, in one or more embodiments, the density of body 31 may be less than 20 pounds per cubic foot (97.6 kg/m²), in other embodiments less than 10 pounds per cubic foot (48.8 kg/m²), in other embodiments less than 6 pounds per cubic foot (29.3 kg/m²), in other embodiments less than 5.7 pounds per cubic foot (28.8 kg/m²), in other embodiments less than 5.5 pounds per cubic foot (28.3 kg/m²), in other embodiments less than 5.2 pounds per cubic foot (27.8 kg/m²), in other embodiments less than 5.0 pounds per cubic foot (27.3 kg/m²), and still in other embodiments less than 4.7 pounds per cubic foot (26.9 kg/m²).

In other embodiments, body 31 has a relatively low density. For example, body 31 may be characterized by a foam density (ASTM C303) that is less than 2.5 pounds per cubic foot, in other embodiments less than 2.0 pounds per cubic foot, in other embodiments less than 1.9 pounds per cubic foot, and still in other embodiments less than 1.8 pounds per cubic foot. In one or more embodiments, these polyurethane or polyisocyanurate insulation layers may also be characterized by having a density that is greater than 1.50 pounds per cubic foot and optionally greater than 1.55 pounds per cubic foot.

In one or more embodiments, body 31 is characterized by an ISO Index, as determined by PIR/PUR ratio as determined by IR spectroscopy using standard foams of known index (note that ratio of 3 PIR/PUR provides an ISO Index of 300), of at least 270, in other embodiments at least 285, in other embodiments at least 300, in other embodiments at least 315, and in other embodiments at least 325. In these or other embodiments, the ISO Index is less than 360, in other embodiments less than 350, in other embodiments less than 340, and in other embodiments less than 335.

### Manufacture of Geofoam Composite

### Laminator

The geofoam composites of this invention can be manufactured by using known techniques. In one or more embodiments, the composites may be made within a laminator construction line where foam is deposited onto a continuously moving web of the facer described herein. Consistent with the teachings of this invention, the foam material is deposited onto a planar surface of the facer and contacts the coating layer. It is believed that a technologically useful bond is created between the foaming material and the coating material that forms the coating layer and/or the penetrated coating. As the foam begins to rise, a second facer, which may also conform to the facers of this invention, is positioned above the foam and the composite is run through the laminator. In positioning the top facer, the coating on the planar surface of the second facer is also contacted to the foam.

### Manufacture of Glass Mat

The glass fiber mat can be formed from any suitable process. For example, these glass fiber mats can be formed from an aqueous dispersion of glass fibers. In such process, a resin binder can be applied to a wet non-woven web of fibers and after removing excess binder and water, the web can be dried and heated to cure the resin binder to form the non-woven mat product. Non-woven glass fiber mats can also be made by chopping dry strands of glass fibers bound together with a binder to form chopped strand, collecting the chopped strand on a moving conveyor in a random pattern, and bonding the chopped strand together at their crossings by dusting a dry, powdered thermoplastic binder like a polyamide, polyester, or ethylene vinyl acetate on wetted chopped strands followed by drying and curing the binder.

### Application of Coating to Glass Mat

In one or more embodiments, a coating composition is applied to each of the planar surfaces of the glass mat. In other words, a first binding composition may be applied to a first planar surface (which may be referred to as an upper surface), and a second binding composition may be applied to a second planar surface (which may be referred to as a lower surface) opposite the first planar surface. The first and second binding compositions may be the same. Any method suitable for applying a binding composition or coating to a glass fiber mat or impregnating a glass fiber mat with a binding composition or coating may be used to apply the first binding composition to the upper surface of the at least one glass fiber mat and the second binding composition to the lower surface of the at least one glass fiber mat. The first and second binding composition can be applied by air spraying, dip coating, knife coating, roll coating, or film application such as lamination/heat pressing. The ability to produce coated facers is known as described in U.S. Pat. Nos. 5,102,728, 5,112,678, and 7,138,346, which are incorporated herein by reference.

### Manufacture of Foam Core

In general, and in a manner that is conventional in the art, the geofoams of the present invention may be produced by developing or forming a polyurethane and/or polyisocyanurate foam in the presence of a blowing agent. The foam may be prepared by contacting an A-side stream of reagents with a B-side stream of reagents and depositing the mixture or developing foam onto a facer positioned on a laminator. As is conventional in the art, the A-side stream includes an isocyanate and the B-side includes an isocyanate-reactive compound.

According to one or more aspects of this invention, the facer, which as described above includes a coating layer on at least one planar surface of a fibrous mat, is positioned on the laminator so that the developing foam is applied to the coating layer. As a result of this manufacturing technique, the interfacial region is created between the fibrous mat and the foam core.

In one or more embodiments, processes for the manufacture of polyurethane or polyisocyanurate coverboards, including those having a relatively high density, are known in the art as described in U.S. Pat. Nos. 8,453,390 7,972,688, 7,387,753, 7,612,120, 6,774,071, 6,372,811, 6,117,375, 6,044,604, 5,891,563, 5,573,092, and U.S. Publication Nos. 2004/0102537, 2004/0109983, 2003/0082365, and 2003/0153656, which are incorporated herein by reference.

The A-side stream typically only contains the isocyanate, but, in addition to isocyanate components, the A-side stream may contain flame-retardants, surfactants, blowing agents and other non-isocyanate-reactive components.

Suitable isocyanates are generally known in the art. Useful isocyanates include aromatic polyisocyanates such as diphenyl methane, diisocyanate in the form of its 2,4′-, 2,2′-, and 4,4′-isomers and mixtures thereof, the mixtures of diphenyl methane diisocyanates (MDI) and oligomers thereof known in the art as “crude” or polymeric MDI having an isocyanate functionality of greater than 2, toluene diisocyanate in the form of its 2,4′ and 2,6′-isomers and mixtures thereof, 1,5-naphthalene diisocyanate, and 1,4′ diisocyanatobenzene. Exemplary isocyanate components include polymeric Rubinate 1850 (Huntsmen Polyurethanes), polymeric Lupranate M70R (BASF), and polymeric Mondur 489N (Bayer).

The B-side stream, which contains isocyanate reactive compounds, may also include flame retardants, catalysts, emulsifiers/solubilizers, surfactants, blowing agents, fillers, fungicides, anti-static substances, water and other ingredients that are conventional in the art.

An exemplary isocyanate-reactive component is a polyol. The terms polyol or polyol component include diols, polyols, and glycols, which may contain water as generally known in the art. Primary and secondary amines are suitable, as are polyether polyols and polyester polyols. Useful polyester polyols include phthalic anhydride based PS-2352 (Stepan), phthalic anhydride based polyol PS-2412 (Stepan), teraphthalic based polyol 3522 (Kosa), and a blended polyol TR 564 (Oxid). Useful polyether polyols include those based on sucrose, glycerin, and toluene diamine. Examples of glycols include diethylene glycol, dipropylene glycol, and ethylene glycol. Suitable primary and secondary amines include, without limitation, ethylene diamine, and diethanolamine. In one embodiment a polyester polyol is employed. In one or more embodiments, the present invention may be practiced in the appreciable absence of any polyether polyol. In certain embodiments, the ingredients are devoid of polyether polyols.

Catalysts are believed to initiate the polymerization reaction between the isocyanate and the polyol, as well as a trimerization reaction between free isocyanate groups when polyisocyanurate foam is desired. While some catalysts expedite both reactions, two or more catalysts may be employed to achieve both reactions. Useful catalysts include salts of alkali metals and carboxylic acids or phenols, such as, for example potassium octoate; mononuclear or polynuclear Mannich bases of condensable phenols, oxo-compounds, and secondary amines, which are optionally substituted with alkyl groups, aryl groups, or aralkyl groups; tertiary amines, such as pentamethyldiethylene triamine (PMDETA), 2,4,6-tris [(dimethylamino)methyl]phenol, triethyl amine, tributyl amine, N-methyl morpholine, and N-ethyl morpholine; basic nitrogen compounds, such as tetra alkyl ammonium hydroxides, alkali metal hydroxides, alkali metal phenolates, and alkali metal acholates; and organic metal compounds, such as tin(II)-salts of carboxylic acids, tin(IV)-compounds, and organo lead compounds, such as lead naphthenate and lead octoate.

Surfactants, emulsifiers, and/or solubilizers may also be employed in the production of polyurethane and polyisocyanurate foams in order to increase the compatibility of the blowing agents with the isocyanate and polyol components.

Surfactants may serve two purposes. First, they may help to emulsify/solubilize all the components so that they react completely. Second, they may promote cell nucleation and cell stabilization. Exemplary surfactants include silicone co-polymers or organic polymers bonded to a silicone polymer. Although surfactants can serve both functions, a more cost effective method to ensure emulsification/solubilization may be to use enough emulsifiers/solubilizers to maintain emulsification/solubilization and a minimal amount of the surfactant to obtain good cell nucleation and cell stabilization. Examples of surfactants include Pelron surfactant 9920, Goldschmidt surfactant B8522, and GE 6912. U.S. Pat. Nos. 5,686,499 and 5,837,742 are incorporated herein by reference to show various useful surfactants.

Suitable emulsifiers/solubilizers include DABCO Kitane 20AS (Air Products), and Tergitol NP-9 (nonylphenol+9 moles ethylene oxide).

Flame Retardants may be used in the production of polyurethane and polyisocyanurate foams, especially when the foams contain flammable blowing agents such as pentane isomers. Useful flame retardants include tri(monochloropropyl) phosphate, tri-2-chloroethyl phosphate, phosphonic acid, methyl ester, dimethyl ester, and diethyl ester.

Useful blowing agents include isopentane, n-pentane, cyclopentane, alkanes, (cyclo) alkanes, hydrofluorocarbons, hydrochlorofluorocarbons, fluorocarbons, fluorinated ethers, alkenes, alkynes, carbon dioxide, and noble gases. U.S. Pat. No. 5,182,309 is incorporated herein by reference to show useful blowing agents. Depending on the required density of the board, the amount of blowing agent may need to be decreased up to about 95% from a standard formulation. The amount of water may also, optimally, be reduced. The less blowing agent used, the less catalyst is generally used.

### INDUSTRIAL APPLICABILITY

### Road Construction

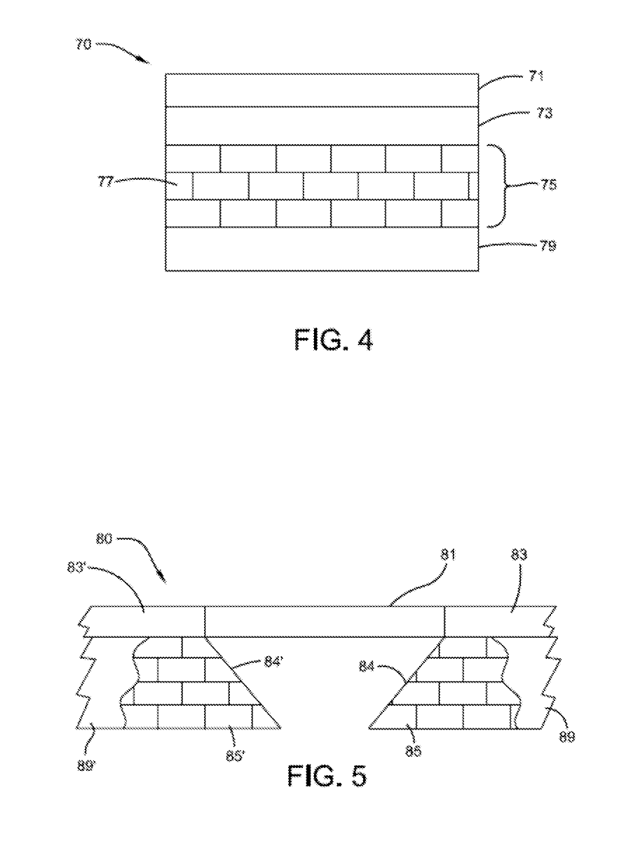

In one or more embodiments, the polyisocyanurate composite geofoams of the present invention may be employed in road construction. As the skilled person understands, these geofoam composites can be used to replace compressible soils or heavy fill materials and thereby reduce the loads applied to the underlying environment. For example, as shown in FIG. 4, road construction 70 may include a finished surface 71 deposited on optional barrier layer 73. Below finished surface 71 or barrier layer 73 is geofoam assembly 75, which may include a plurality of goefoam composites 77 as described herein. Geofoam composites may be positioned on an underlying environment 79.

### Bridge Abutments

In one or more embodiments, the polyisocyanurate composite geofoams of the present invention can be employed to fill bridge abutments and thereby support roads without providing undue stress to the underlying environment. In a similar fashion, the geofoam composites of the present invention can be used to underfill bridges and bridge ramps.

An exemplary bridge abutment 80 is shown is FIG. 5, where bridge structure 81 spans roadways 83 and 83′. Abutments 84 and 84′, which are proximate to the location where bridge 81 meets roadways 83 and 83′, respectively, may include geofoam assemblies 85 and 85′, which include one or more geofoam composites as described herein. Geofoam assemblies 85 and 85′ may be positioned proximate to the environment 89 and 89′ existing below roadway 83 and 83′.

### Railroad Beds

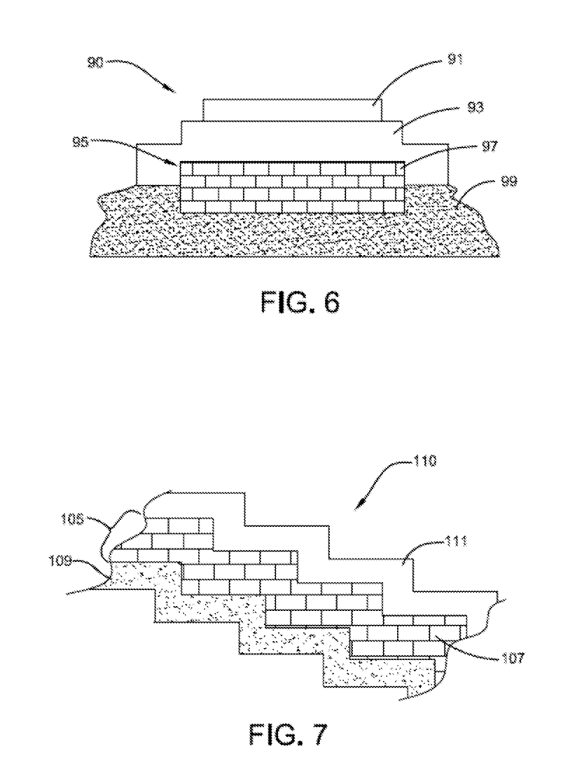

In one or more embodiments, the polyisocyanurate composite geofoams of the present invention can be used to support railway loads in railroad beds. For example, as shown in FIG. 6, railroad bed 90 includes rail system 91 positioned over optional barrier material 93, which is positioned over geofoam assembly 95, which includes one or more geofoam composites 97 according to aspects of the invention. Geofoam assembly 95 may be positioned over the underlying environment 99.

### Stadium and Theater Structures

In one or more embodiments, the polyisocyanurate composite geofoams of the present invention may be used to create desired profiles within stadiums and theaters. Once a desired configuration has been constructed, finish concrete or other material can be applied over the geofoam composites. For example, stadium structure 110, as shown in FIG. 7, may include finished surface 111 and geofoam assembly 105, which may include one or more geofoam composites 107. Geofoam assembly 105 may be positioned on underlying structural supports 109.

### Airport Runways and Taxiways

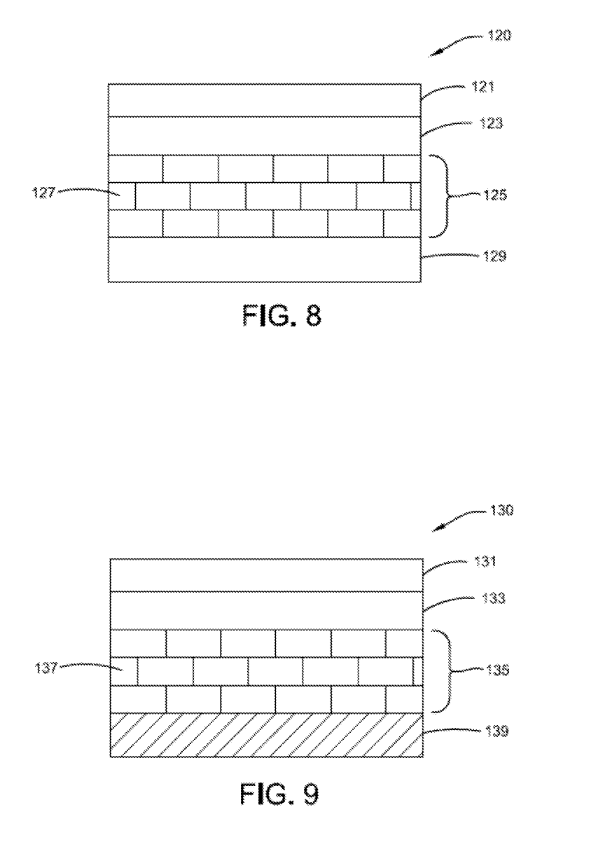

In one or more embodiments, the polyisocyanurate composite geofoams of the present invention can be used as underlying subgrade materials for airport runways and taxiways. An exemplary airport runway 120 is shown in FIG. 8, which includes a finished surface 121 deposited on optional barrier layer 123. Below finished surface 121 or barrier layer 123 is geofoam assembly 125, which may include a plurality of geofoam composites 127 as described herein. Geofoam assembly 125 may be positioned on an underlying environment 129.

### Parking Garages

In one or more embodiments, the polyisocyanurate composite geofoams of the present invention can be used as underlying materials in parking garages and walkways. For example, parking garage 130, as shown in FIG. 9, may include finished surface 131, optional barrier layer 133, and geofoam assembly 135, which may include one or more geofoam composites 137 according to embodiments of this invention. Geofoam assembly 135 may be positioned on underlying structural supports 139.

### Residential Use

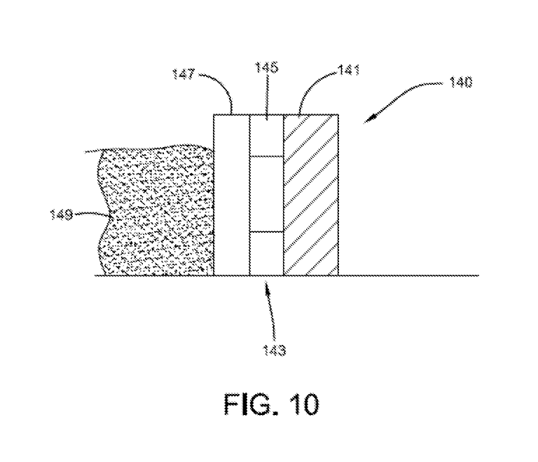

In one or more embodiments, the polyisocyanurate composite geofoams of the present invention can be used in residential applications. For example, they can be used as exterior insulation layers in subsurface application. For example, the geofoam composites can be positioned adjacent to a subsurface exterior wall. For example, FIG. 10 shows the sub-surface structure 140 of a residential building (e.g. home) having exterior sub-surface wall 141. Adjacent thereto is geofoam assembly 143 including one or more geofoam composites 145 according to embodiments of the invention. Optional exterior layer 147, which may include a coating of water-resistant material, may be applied to the exterior surface of the geofoam assembly 143 on a surface thereof adjacent to the external environment (e.g. slag or fill) 149.

Various modifications and alterations that do not depart from the scope and spirit of this invention will become apparent to those skilled in the art. This invention is not to be duly limited to the illustrative embodiments set forth herein.

1. A road system comprising:
i. a finished road surface; and
ii. a geofoam positioned below the road surface, where the geofoam includes a foam core and a facer including a fibrous mat and an interfacial region disposed between said foam core and said fibrous mat.

2. The road system of claim 1 wherein the fibrous mat is a fiberglass mat.

3. The road system of claim 1 wherein the interfacial region comprises a coating material.

4. The road system of claim 3 wherein the coating material comprises a binder and an inorganic filler.

5. The road system of claim 4 wherein the coating material is dispersed within interstices of the fibrous mat.

6. The road system of claim 1 wherein the facer further comprises a coating layer adjacent to the foam core opposed to the interfacial region.

7. The road system of claim 6 wherein the coating layer is dispersed within interstices of the fibrous mat.

8. A railway system comprising:
i. a railway; and
ii. a geofoam positioned below the railway, where the geofoam includes a foam core and a facer including a fibrous mat and an interfacial region disposed between said foam core and said fibrous mat.

9. The railway system of claim 8 wherein the fibrous mat is a fiberglass mat.

10. The railway system of claim 8 wherein the interfacial region comprises a coating material.

11. The railway system of claim 10 wherein the coating material comprises a binder and an inorganic filler.

12. The railway system of claim 11 wherein the coating material is dispersed within interstices of the fibrous mat.

13. The railway system of claim 8 wherein the facer further comprises a coating layer adjacent to the foam core opposed to the interfacial region.

14. The railway system of claim 13 wherein the coating layer is dispersed within interstices of the fibrous mat.

15. An airport runway or taxiway comprising:
i. a finished airport runway or taxiway; and
ii. a geofoam positioned below the airport runway or taxiway, where the geofoam includes a foam core and a facer including a fibrous mat and an interfacial region disposed between said foam core and said fibrous mat.

16. The airport runway or taxiway of claim 15 wherein the fibrous mat is a fiberglass mat.

17. The airport runway or taxiway of claim 15 wherein the interfacial region comprises a coating material.

18. The airport runway of claim 17 wherein the coating material comprises a binder and an inorganic filler.

19. The airport runway or taxiway of claim 18 wherein the coating material is dispersed of interstices within the fibrous mat.

20. The airport runway or taxiway of claim 15 wherein the facer further comprises a coating layer adjacent to the foam core opposed to the interfacial region.

21. The airport runway of claim 20 wherein the coating layer is dispersed within interstices of the fibrous mat.
